(19) United States
(12) Patent Application Publication
(10) Pub. No.: US 2004/0028384 A1
(43) Pub. Date: Feb. 12, 2004

(54) Digital recording/reproducing apparatus

(76) Inventors: Ken Fujii, Tokyo (JP); Yasufumi Takasugi, Tokyo (JP); Takashi Namioka, Tokyo (JP); Nobuyuki Kobayashi, Tokyo (JP)

Correspondence Address: GREENBLUM & BERNSTEIN, P.L.C., 1950 ROLAND CLARKE PLACE, RESTON, VA, 20191, US

(21) Appl. No.: 10/432,596

(22) PCT Filed: Dec. 12, 2001
(86) PCT No.: PCT/JP01/10922

(30) Foreign Application Priority Data
Dec. 14, 2000 (JP) 2000-379854

(51) Int. Cl. H04N 5/783

(52) U.S. Cl. 386/69; 386/70

(57) ABSTRACT

A digital recording/reproducing apparatus according to the present invention is configured to be capable of mounting a removable recording medium (M) therein, and includes a recording control section (10) for recording record data (D_{S}) on the recording medium (M), and a reproducing control section (10) for carrying out reproduction based on the record data (D_{S}) recorded on the recording medium (M). The digital recording/reproducing apparatus (1) comprises an index data generating section (4) for generating index data (D_{ID}) for detecting a cue position used to cue a predetermined recording position in the record data (D_{S}) at a time of cue reproduction. The recording control section (10) automatically records a plurality of items of the index data (D_{ID}) in the record data (D_{S}) according to a predetermined rule during recording of the record data (D_{S}) on the recording medium (M), and the reproducing control section (10) retrieves an item of the index data (D_{ID}) in the record data (D_{S}) at the time of cue reproduction to reproduce the record data (D_{S}) from a cue recording position corresponding to the detected item of the index data (D_{ID}).

### TECHNICAL FIELD

This invention relates to a digital recording/reproducing apparatus that is configured to be capable of recording record data on a recording medium configured removable and reproducing the recorded record data from the recording medium.

### BACKGROUND ART

As a digital recording/reproducing apparatus of the above-mentioned kind, there exists an audio recording/reproducing apparatus using a card-type removable memory (hereinafter referred to as a “memory card”) as a recording medium. To record voice e.g. in a lecture meeting hall by using the audio recording/reproducing apparatus, the memory card is mounted in the apparatus, and then a recording button is operated. On this occasion, the audio recording/reproducing apparatus converts an analog audio signal input via a microphone to a digital form to thereby generate audio data, and then records the audio data on the memory card mounted in the apparatus. Generation of audio data is continuously carried out thereafter until a stop button is operated, and the generated audio data are sequentially recorded on the memory card. Thus, the voice in the meeting hall is recorded on the memory card.

On the other hand, to reproduce the recorded voice, the memory card storing the audio data to be reproduced is mounted in the apparatus, and then a playback button is operated. When the playback button is operated, the audio recording/reproducing apparatus reads out the audio data from the memory card, and generates an analog audio signal by converting the audio data to an analog form, followed by generating voice or sound via a loudspeaker or an earphone. Thus, the voice in the lecture meeting hall is reproduced. In this case, e.g. when reproduction of voice concerning a matter discussed as a subject in the second half of a meeting is desired, the first half of the audio data is skipped, and the audio data is fast forwarded to a recording position of the audio data corresponding to a desired reproducing position. More specifically, for instance, an operator actually checks voice through fast forward reproduction, or after stopping reproduction by operating the stop button, fast forwards the audio data by a seemingly adequate amount by operating a fast forward button through rough estimation based on a recording time period displayed in a display section, and then operates the stop button. Then, the playback button is operated for reproduction of the audio data. At this time, the operator judges whether or not the desired reproducing position is reached, and if the amount of fast forward is judged to be insufficient, the audio data is fast forwarded by a desired amount again. On the other hand, if the amount of fast forward is judged to be too large, the operator carries out rewinding operation by a desired amount through rough estimation based on a displayed recording time period. As described above, it is possible to locate a desired reproducing position by carrying out fast forward or rewinding operation while checking reproduced contents, and then reproduce voice from the desired reproducing position.

### DISCLOSURE OF THE INVENTION

Through the study of the above prior art, the inventors found out the following problems: When the audio recording/reproducing apparatus is used to reproduce audio data from a desired reproducing position, it is required to locate the desired reproducing position by carrying out fast forward or rewinding operation while checking reproduced contents. However, it is very difficult to locate the desired reproducing position by a single fast forward operation, and hence it is necessary to alternately carry out checking of a reproduced content, and fast forward or rewinding operation which necessitates actually listening to voice or sound and/or rough estimation based on a displayed recording time period, a number of times. Therefore, it takes much time to locate the desired reproducing position, and the operations therefor are complicated and troublesome. To overcome this problem, there has been proposed an audio reproducing apparatus which is capable of carrying out fast forward operation and at the same time performing reproduction according to the speed of the fast forward operation. When this audio reproducing apparatus is used, the operation itself is relatively easy, since the audio data is fast forwarded while performing reproduction thereof simply by operating a fast forward button during reproduction. However, since it is necessary to continue the fast forward operation while checking reproduced contents from the leading recording position to a desired reproducing position, it still takes much time to locate the desired reproducing position.

The invention has been made to provide a solution to the above problems, and it is a main object of the invention to provide a digital recording/reproducing apparatus that is capable of easily detecting a desired reproducing position.

A digital recording/reproducing apparatus according to the invention, which is configured to be capable of mounting a removable recording medium therein, and includes a recording control section for carrying out recording of record data on the recording medium, and a reproducing control section for carrying out reproduction based on the record data recorded on the recording medium, is characterized by comprising an index data generating section for generating index data for detecting a cue position used to cue a predetermined recording position in the record data at a time of cue reproduction, wherein the recording control section automatically records a plurality of items of the index data in the record data according to a predetermined rule at a time of recording of the record data on the recording medium, and the reproducing control section retrieves an item of the index data in the record data at the time of cue reproduction to reproduce the record data from a cue recording position corresponding to the retrieved item of the index data.

According to this digital recording/reproducing apparatus, the recording control section automatically records a plurality of items of index data in record data according to the predetermined rule, and the reproducing control section retrieves an item of the index data in the record data at the time of cue reproduction to reproduce the record data from a cue recording position corresponding to the item of the index data. Therefore, at the time of reproduction, differently from a method in which a desired recording position is cued by fast forwarding or rewinding record data by an adequate amount while reproducing the record data for checking contents thereof, record data corresponding to items of the index data are automatically located and reproduced by the reproducing control section. This makes is unnecessary for an operator to carry out any special operation at the time of recording record data, and enables him to easily locate a desired reproducing position in a short time period at the time of reproducing the record data.

Preferably, at the time of recording of the record data, the recording control section automatically records the index data at least at predetermined time intervals. According to this method, at the time of reproducing the record data, respective recording positions of items of the index data recorded e.g. at predetermined time intervals are cued, and the record data are reproduced from the respective recording positions, so that it is possible to easily locate a desired reproducing position in a short time period.

Further, it is preferred that when a recording element of the record data changes at a predetermined rate of change at the time of recording of the record data, the recording control section records an item of the index data for detecting the cue position corresponding to the record data to be recorded. It should be noted that the “recording element” in the invention includes an audio level when the record data is audio data, and a luminance level when the record data is video data. This configuration makes it very easy to automatically locate a recording position of record data which is likely to correspond to a desired reproducing position and reproduce the record data therefrom.

Further, it is preferred that the reproducing control section repeatedly carries out a reproducing/retrieving process, the reproducing/retrieving process including retrieving an item of the index data while reproducing the record data, continuing the reproduction of the record data being reproduced, for a predetermined time period, and then reproducing the record data from the cue recording position corresponding to the retrieved index data for the predetermined time period. According to this configuration, an item of the index data is retrieved during reproduction of record data, and after continuing the reproduction of the record data for a predetermined time period, the record data is reproduced from a cue recording position corresponding to the retrieved item of the index data for a predetermined time period. Therefore, it is possible to locate a desired reproducing position more speedily and easily than by a conventional method in which a recording position of a desired segment of the record data is retrieved by fast forwarding the record data while reproducing the same.

Furthermore, it is preferred that the index data generating section generates order information for specifying an order of being cued by the reproducing control section at the time of cue reproduction, such that the order information is included in the index data. According to this configuration, cue reproduction can be executed e.g. by retrieving every fourth index data item or by retrieving odd-numbered index data items, and hence it is possible to easily locate a desired reproducing position in a short time particularly when audio data recorded over a long time period is reproduced.

Moreover, it is preferred that the digital recording/reproducing apparatus is configured to be capable of performing recording of audio data as the record data and reproduction of voice or sound based on the audio data, and when the recording control section determines by audio analysis of the audio data to be recorded on the recording medium that the audio data to be recorded corresponds to a predetermined word or a predetermined sound component, the recording control section records the index data for detecting the cue position corresponding to the audio data to be recorded. According to this configuration, cue reproduction can be performed very easily from a recording position of audio data which is likely to correspond to a desired reproducing position, such as a word uttered for a change of a subject.

It should be noted that the present disclosure relates to the subject matter included in Japanese Patent Application No. 2000-379854 filed on Dec. 14, 2000, and it is apparent that all the disclosures therein are incorporated herein by reference.

### BRIEF DESCRIPTION OF DRAWINGS

FIG. 1 is a block diagram showing the arrangement of an audio recording/reproducing apparatus 1 according to an embodiment of the invention;

FIG. 2 is an area map showing an example of recording areas on a memory card M which is mounted in the audio recording/reproducing apparatus 1; and

FIG. 3 is a structure map showing an example of a structure of audio data D_{S}.

### BEST MODE FOR CARRYING OUT THE INVENTION

A preferred embodiment of the present invention will be described below with reference to the accompanying drawings.

First, the arrangement of the audio recording/reproducing apparatus 1 will be described in detail with reference to the drawings.

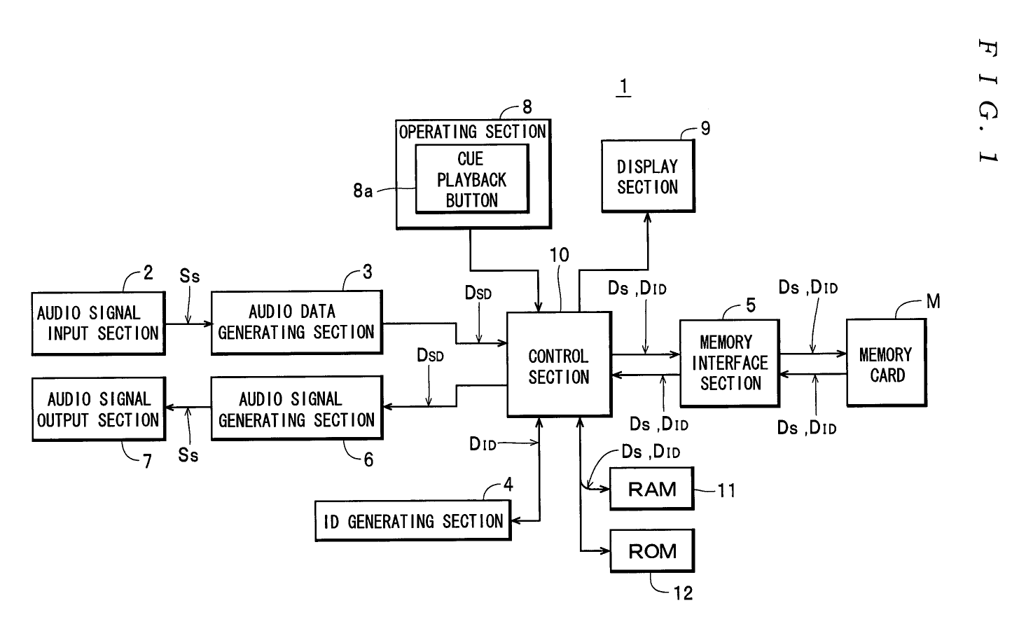

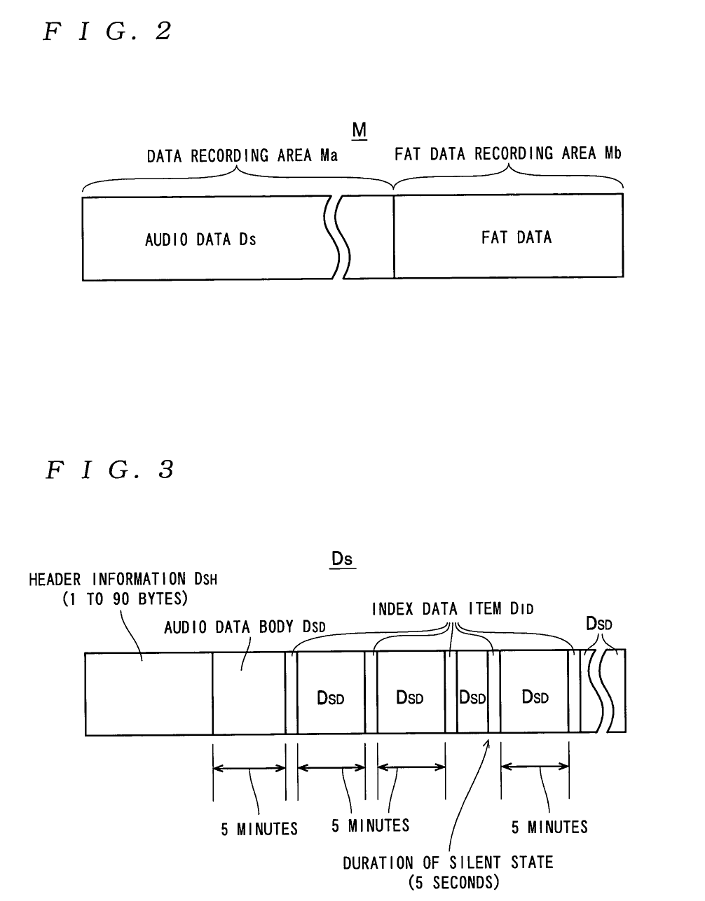

The audio recording/reproducing apparatus 1 shown in FIG. 1 is a portable voice recorder in which a memory card M can be mounted as a recording medium. The audio recording/reproducing apparatus 1 performs recording of audio data D_{S} generated by conversion of analog audio signals S_{S} to a digital form on the memory card M, and reproduction of analog audio signals S_{S} generated by conversion of the audio data D_{S} recorded on the memory card M to an analog form. In the present embodiment, the memory card M corresponds to a recording medium in the present invention and is implemented by an existing card-type removable memory formed by sealing a semiconductor chip with resin. The memory card M stores audio data D_{S} and its FAT data. As shown in FIG. 2, the memory card M has a recording area comprised of a data recording area Ma for storing audio data D_{S} corresponding to record data in the present invention and a FAT data recording area Mb for storing FAT data concerning the audio data D_{S} recorded in the data recording area Ma. On the other hand, as shown in FIG. 1, the audio recording/reproducing apparatus 1 is comprised of an audio signal input section 2, an audio data generating section 3, an ID generating section 4, a memory interface section 5, an audio signal generating section 6, an audio signal output section 7, an operating section 8, a display section 9, a control section 10, a RAM 11, and a ROM 12.

The audio signal input section 2 amplifies an analog audio signal collected by a microphone, not shown, and then low-pass filters the amplified analog audio signal to thereby generate an analog audio signal S_{S}. The audio data generating section 3 converts the analog audio signal S_{S} to digital data and compresses the digital data to generate an audio data body D_{SD}. The ID generating section (index data generating section) 4 generates a plurality of index data items D_{ID}, D_{ID}, . . . , under the control of the control section 10. Each of the index data items D_{ID}contains order information for specifying its place in an order of generation (order of being cued). The memory interface section 5 includes a connector on which a memory card M can be mounted, and carries out recording of audio data D_{S} and FAT data on the memory card M as well as reading of the audio data D_{S} and the FAT data from the memory card M under the control of the control section 10. The audio signal generating section 6 expands the audio data body D_{SD} to decode the same to the digital data, and then converts the decoded digital data to the analog audio signal S_{S}. The audio signal output section 7 filters the analog audio signal S_{S} by a predetermined band-pass filter, and then amplifies the filtered analog audio signal S_{S}, followed by generating voice or sound via a loudspeaker. The audio recording/reproducing apparatus 1 also has an earphone jack, not shown, arranged therein, and hence when an earphone is connected to the earphone jack, voice or sound is produced from the analog audio signal via the earphone instead of via the loudspeaker.

The operating section 8 is comprised of a plurality of operation buttons including a recording button, a playback button, a cue playback button 8a, a fast forward button, a rewinding button, a stop button, a menu button, and a power button. The display section 9 is formed by an LCD panel on which are displayed the remaining recordable capacity of a memory card M, elapsed time from the start of recording/reproduction, the remaining capacity of a battery, not shown, and so forth. The control section 10 corresponds to a recording control section and a reproducing control section in the present invention and is implemented e.g. by a 16-bit CPU. The control section 10 executes control of the audio signal input section 2, the audio data generating section 3, the ID generating section 4, the audio signal generating section 6, and the audio signal output section 7, in response to button operations of the operating section 8, recording control of audio data D_{S} and others on the memory card M via the memory interface section 5, reading control of the audio data D_{S} and others from the memory card M, and so forth. The RAM 11 temporarily stores the audio data D_{S} being recorded on the memory card M, index data items D_{ID}, results of arithmetic operations by the control section 10, and so forth. Further, the ROM 12 stores operating programs executed by the control section 10, data of default setting values of the audio recording/reproducing apparatus 1, and so forth.

Next, a method of using the audio recording/reproducing apparatus 1 will be described with reference to the drawings.

To record voice e.g. in a lecture meeting hall, a memory card M is mounted in the memory interface section 5. At the time of recording, in the audio recording/reproducing apparatus 1, the control section 10 determines whether or not the memory card M is mounted in the memory interface section 5, and if it is determined that the memory card M is mounted, card information including the recordable capacity and remaining recordable capacity of the memory card M is obtained from the memory card M via the memory interface section 5 and stored in the RAM 11. Then, memory information including a recordable time period calculated based on the remaining recordable capacity contained in the obtained card information is displayed on the display section 9.

Then, when the recording button is operated, the control section 10 generates audio data D_{S} based on an audio data body D_{SD}. input via the audio signal input section 2 and the audio data generating section 3. More specifically, the audio signal input section 2 amplifies an analog audio signal input via the microphone and then filters the amplified analog audio signal to generate an analog audio signal S_{S} and output the same, and the audio data generating section 3 converts the analog audio signal S_{S} to digital data and then compresses the digital data to output the compressed digital data as the audio data body D_{SD}. Subsequently, as shown in FIG. 3, the control section 10 adds header information D_{SH} of approximately 90 bytes including the name and recording date of a file of recorded data to the audio data body D_{SD} to thereby generate audio data D_{S}. It should be noted that at this time point, the audio data D_{S} is formed by the audio data body D_{SD} generated immediately after the start of the recording and the header information D_{SH} alone, and hence there exist neither index data items D_{ID}, D_{ID}, . . . appearing in the figure nor audio data bodies D_{SD} subsequent to the respective index data items D_{ID}. Then, the control section 10 causes the RAM 11 to store the audio data D_{S} temporarily. Thereafter, the control section 10 keeps on with generation of the audio data D_{S} until the stop button is operated. During this time period, the control section 10 reads out the audio data D_{S} from the RAM 11 and sequentially records them in the data recording area Ma of the memory card M via the memory interface section 5.

In the process, the control section 10 causes the ID generating section 4 to generate index data items D_{ID}automatically, and the RAM 11 to store these. The control section 10 reads out the index data items D_{ID}from the RAM 11 e.g. at time intervals of five minutes to record each as a portion of the audio data D_{S} on the memory card M. In addition to the recording of the index data items D_{ID}at time intervals of five minutes, if it is determined that an audio data body D_{SD} generated from voice or sound whose audio level (corresponding to a recording element in the present invention) has suddenly dropped (e.g. voice or sound whose audio level has dropped from the immediately preceding audio level by 20 dB or so, or a noise in a nearly silent state) has been continuously input for more than five seconds, the control section 10 reads out an index data item D_{ID}from the RAM 11 to record the same as a portion of the audio data D_{S} on the memory card M. Then, when five minutes elapses after the recording of the index data item D_{ID}, the recording of the index data items D_{ID}at time intervals of five minutes is resumed. In the meanwhile, if input of audio data representative of a silent state continues more than five seconds, an index data item D_{ID}is recorded at this time point. The above processing is repeatedly carried out, whereby as shown in FIG. 3, index data items D_{ID}are each recorded in the audio data D_{S} in a manner subsequent to an audio data body D_{SD} corresponding to 5-minute recording as well as to an audio data body D_{SD} having its audio level suddenly dropped. In this case, each of the index data items D_{ID}contains the order information enabling specification of its place in the order of being recorded (order of being cued), in which order the index data item D_{ID}recorded first is in the first place.

On the other hand, to reproduce the audio data D_{S} recorded on the memory card M, it is possible to select one of two reproducing methods described below.

When a first reproducing method is selected, the audio recording/reproducing apparatus 1 continuously reproduces the audio data D_{S} from the head to the tail. In the case of selecting this reproducing method, the playback button is operated in the state of the memory card M mounted in the memory interface section 5. At the time of reproduction, the control section 10 reads out the audio data D_{S} from the memory card M and transfers the audio data bodies D_{SD} after removing the header information D_{SH} and the index data items D_{ID}, D_{ID}D_{ID}, . . . from the audio data D_{S}, to the audio signal generating section 6, sequentially starting with the first one. Then, the audio signal generating section 6 expands each of the audio data bodies D_{SD} to generate digital data, and converts the digital data to an analog audio signal S_{S}. Subsequently, the audio signal output section 7 filters the analog audio signal S_{S}, and then amplifies the filtered analog audio signal S_{S}, followed by generating voice or sound via the loudspeaker. As a result, voice or sound based on the audio data D_{S} is continuously reproduced.

When a second reproducing method is selected, so-called cue reproduction is performed. To select this method, the cue playback button 8a is operated in the state of the memory card M mounted in the memory interface section 5. At the time of cue reproduction, the control section 10 reads out the audio data D_{S} from the memory card M, and transfers a leading portion corresponding to 3-second recording out of the first audio data body D_{SD} formed by removing the header information D_{SH} from the audio data D_{S}, to the audio signal generating section 6. This causes the audio signal generating section 6 to generate an analog audio signal S_{S} and the audio signal output section 7 to filter and then amplify the generated analog audio signal S_{S}, followed by generating voice or sound via the loudspeaker.

During the above process, the control section 10 retrieves the. index data item D_{ID} recorded first in the audio data D_{S} (in the present example, the index data item D_{ID} recorded after the lapse of five minutes from the start of audio data recording) . Then, when the reproduction of the leading portion of the first audio data body D_{SD}. corresponding to 3-second recording is completed, the control section 10 transfers to the audio signal generating section 6 the leading portion of an audio data body D_{SD} corresponding to 3-second recording from a cue recording position corresponding to the detected index data item D_{ID}(in the FIG. 3 example, the leading portion of the audio data body D_{SD}, which was recorded subsequently to the first index data item D_{ID}and corresponds to 3-second recording executed after the lapse of five minutes from the start of the audio data recording). Subsequently, during the generation of voice corresponding to the transferred portion of the audio data body D_{SD}, the control section 10 retrieves an index data item D_{ID} recorded second (in the FIG. 3 example, an index data item D_{ID} recorded after the lapse of ten minutes from the start of the audio data recording). Then, after completion of the reproduction of voice generated from the portion of the audio data body D_{SD} corresponding to 3-second recording from the cue recording position corresponding to the first index data item D_{ID}, the control section 10 transfers to the audio signal generating section 6 the leading portion of an audio data body D_{SD} corresponding to 3-second recording from a cue recording position corresponding to the second index data item D_{ID} (in the present example, the leading portion of the audio data body D_{SD}, which was recorded subsequently to the second index data item D_{ID} and corresponds to 3-second recording executed after the lapse of ten minutes from the start of the audio data recording). Thereafter, the control section 10 repeatedly carries out processing similar to the above.

In the meanwhile, when an index data item D_{ID} is detected which was recorded after a silent state had continued more than five seconds during the recording of the audio data D_{S}, the leading portion of an audio data body D_{SD}, which was recorded subsequently to the index data item D_{ID} and corresponds to 3-second recording, is reproduced. Therefore, when subjects or speakers were changed in a lecture meeting or the like, cue reproduction is automatically performed from the leading portion of each different subject or the like. The above processing is continuously carried out until the playback button or the stop button is operated. As a result, portions of voice corresponding to 3-second recording are automatically reproduced sequentially in a skipping manner, so that an operator can readily grasp the changes of the subjects, and so forth. It should be noted that since each index data item D_{ID} recorded by the audio recording/reproducing apparatus 1 contains the order information, if a retrieval condition e.g. a rule of retrieving every fourth index data item D_{ID} or for retrieving odd-numbered index data items D_{ID} is set before the start of cue reproduction, it is possible to retrieve a desired reproducing position more speedily particularly when audio data D_{S} recorded over a long time period is reproduced.

On the other hand, if cue reproduction of voice or sound corresponding to a desired reproducing position is performed, the operator operates the playback button, whereby the audio recording/reproducing apparatus 1 stops the cue reproduction and reproduces the voice by a normal reproducing method. More specifically, the control section 10 transfers audio data bodies D_{SD} to the audio signal generating section 6 continuously from a reproduction start position of an audio data body D_{SD} corresponding to the voice being reproduced for cue reproduction (i.e. from a cue recording position corresponding to a predetermined index data item D_{ID}). The control section 10 executes this data transfer while removing index data items D_{ID}, D_{ID}, . . . contained in the audio data D_{S}. As a result, voice corresponding to the transferred audio data bodies D_{SD} is sounded via the loudspeaker. On the other hand, when the operator determines that the voice being reproduced does not correspond to the desired reproducing position, he operates the cue playback button 8a again. In this case, the processing for cue reproduction is resumed.

As described above, according to the audio recording/reproducing apparatus 1, index data items D_{ID} are recorded e.g. at intervals of five minutes during recording of audio data D_{S}, which enables segments of audio data each recorded over a time period of five minutes to be sequentially reproduced for three seconds simply by operating the cue playback button 8a once. Therefore, differently from the conventional audio recording/reproducing apparatus in which it is required to operate a playback button, a fast forward button, a rewinding button, and a stop button sequentially to locate a desired reproducing position, the audio recording/reproducing apparatus 1 is capable of locating a desired reproducing position very easily. Further, since an index data item D_{ID} is automatically recorded when a silent state has continued more than five minutes during recording of audio data D_{S}, e.g. when a different subject is starts to be discussed after some duration of a silent state, it is possible to easily detect and reproduce the leading portion of a recorded content concerning the different subject during cue reproduction of the audio data D_{S}.

It should be noted that the present invention is not limited to the above embodiment, but it can be modified as required. For instance, although in the embodiment of the invention, description has been given, by way of example, of the recording method in which recording of an index data item D_{ID} is executed at intervals of five minutes as well as after a silent state having continued more than five seconds, a predetermined rule in the present invention is not limited to this, but automatic recording of index data items D_{ID} can be executed according to a different predetermined rule, such as at any desired time intervals or for each predetermined amount of data. Further, although in the above embodiment, an index data item D_{ID} is also recorded after a silent state has continued more than five seconds, a change in a recording element in the present invention is not limited to this, but it is possible to record an index data item D_{ID} when an audio data body D_{SD} exceeding a predetermined audio level is input. Further, although in the embodiment of the invention, the index data items D_{ID} are each recorded immediately before an audio data body D_{SD} corresponding to a voice or sound recorded after the lapse of a predetermined time period from the start of the audio data recording or an audio data body D_{SD} corresponding to a voice or sound recorded after duration of a silent state, the positional relationship between an audio data body D_{SD} and an index data item D_{ID} associated therewith is not limited to the examples shown in the present embodiment, but each index data item D_{ID} and the associated audio data body D_{SD} may be recorded at respective positions spaced from each other by a predetermined interval.

Further, it is possible to equip the control section 10 with an audio analysis function and cause the control section 10 to record index data items D_{ID} under a rule of recording an index data item D_{ID} whenever it is determined that there exists a specific word or phrase, such as “Well”, “Let me see”, “First of all”, “Next” or “By the way”, which can be used to punctuate a speech, or that a specific sound component generated from a specific sound source, such as the sound of a bell or that of a train passing by is input. According to this configuration, since the specific words or phrases, or the sounds having a specific component are likely to correspond to a desired reproducing position, it is possible to locate the desired reproducing position more easily. Furthermore, as to the timing for recording index data items D_{ID}, it is possible not only to record each index data item D_{ID} at any of the above recording timings or at a desired combination of them, but also to provide a button for index data recording in the operating section 8 and operate the button to record an index data item D_{ID} at a recording position the operator desires. According to this method, even when audio data D_{S} is recorded e.g. on a busy and crowded street where sound or noise exceeding a predetermined audio level is constantly generated, it is possible to locate a desired reproducing position with ease afterward by causing the control section 10 to detect the index data item D_{ID} recorded at the desired timing according to the operator's intention.

Further, the digital recording/reproducing apparatus according to the invention is not limited to the audio recording/reproducing apparatus 1 for recording and reproducing audio data D_{S} illustrated in the embodiment, but it can be applied to a video recording/reproducing apparatus for recording and reproducing video data. In this case, in recording of video data, recording elements which change at a predetermined rate of change include an audio level and a luminance level, for instance. Therefore, automatic recording of an index data item D_{ID} can be caused when it suddenly gets bright or dark in a room (change in the luminance level) or when a car runs past or people walking along a sidewalk suddenly decrease in number in an outdoor scene (change in the average value of luminance levels on the whole screen). Further, it goes without saying that record data may be in any suitable form of digital data, including numerical data, and text data. Still further, the audio data D_{S} is not limited to audio data D_{S} generated by converting analog audio signal S_{S} input via a microphone to a digital form, but it may be audio data generated based on an audio signal input e.g. via an audio signal input terminal or audio data obtained via a communication terminal. Moreover, recording media which can be employed in the present invention include not only the memory card M, but also various kinds of removable media including stick-shaped and chip-shaped removable memories, a disk-type digital recording medium, such as an MD, an MO, an FD, a CD-R, a CD-RW, or a DVD-R, and a tape-type digital recording medium, such as a DV, a DAT, or a DDS.

Industrial Applicability

As described above, according to the digital recording/reproducing apparatus of the present invention, the control section causes a plurality of index data items to be automatically recorded in record data according to a predetermined rule, and at the time of cue reproduction, the reproducing control section retrieves index data items in the record data and reproduces the record data from respective cue reproducing positions corresponding to the retrieved index data items. Therefore, at the time of reproduction, differently from the method in which a desired recording position is located by fast forwarding or rewinding record data by an adequate amount while reproducing the record data for checking contents thereof, segments of the record data corresponding to the respective index data items are automatically located by the reproducing control section and reproduced. Thus, the digital recording/reproducing apparatus is realized which requires no special operation by an operator at the time of recording record data and is capable of easily locating a desired reproducing position in a short time period at the time of reproducing the record data.

1. A digital recording/reproducing apparatus configured to be capable of mounting a removable recording medium therein, and including a recording control section for carrying out recording of record data on the recording medium, and a reproducing control section for carrying out reproduction based on the record data recorded on the recording medium,
the digital recording/reproducing apparatus comprising an index data generating section for generating index data for detecting a cue position used to cue a predetermined recording position in the record data at a time of cue reproduction, and
wherein the recording control section automatically records a plurality of items of the index data in the record data according to a predetermined rule at a time of recording of the record data on the recording medium, and the reproducing control section retrieves an item of the index data in the record data at the time of cue reproduction to reproduce the record data from a cue recording position corresponding to the retrieved item of the index data.

2. A digital recording/reproducing apparatus according to claim 1, wherein at the time of recording of the record data, the recording control section automatically records the index data at least at predetermined time intervals.

3. A digital recording/reproducing apparatus according to claim 1, wherein when a recording element of the record data changes at a predetermined rate of change at the time of recording of the record data, the recording control section records an item of the index data for detecting the cue position corresponding to the record data to be recorded.

4. A digital recording/reproducing apparatus according to claim 2, when a recording element of the record data changes at a predetermined rate of change at the time of recording of the record data, the recording control section records an item of the index data for detecting the cue position corresponding to the record data to be recorded.

5. A digital recording/reproducing apparatus according to claim 1, wherein the reproducing control section repeatedly carries out a reproducing/retrieving process, the reproducing/retrieving process including retrieving an item of the index data while reproducing the record data, continuing the reproduction of the record data being reproduced, for a predetermined time period, and then reproducing the record data from the cue recording position corresponding to the retrieved index data for the predetermined time period.

6. A digital recording/reproducing apparatus according to claim 2, wherein the reproducing control section repeatedly carries out a reproducing/retrieving process of retrieving an item of the index data while reproducing the record data, and after the record data has been reproduced for a predetermined time period, reproducing the record data from the cue recording position corresponding to the retrieved index data for the predetermined time period.

7. A digital recording/reproducing apparatus according to claim 3, wherein the reproducing control section repeatedly carries out a reproducing/retrieving process of retrieving an item of the index data while reproducing the record data, and after the record data has been reproduced for a predetermined time period, reproducing the record data from the cue recording position corresponding to the retrieved index data for the predetermined time period.

8. A digital recording/reproducing apparatus according to claim 4, wherein the reproducing control section repeatedly carries out a reproducing/retrieving process of retrieving an item of the index data while reproducing the record data, and after the record data has been reproduced for a predetermined time period, reproducing the record data from the cue recording position corresponding to the retrieved index data for the predetermined time period.

9. A digital recording/reproducing apparatus according to any one of claims 1 to 8, wherein the index data generating section generates order information for specifying an order of being cued by the reproducing control section at the time of cue reproduction, such that the order information is included in the index data.

10. A digital recording/reproducing apparatus according to any one of claims 1 to 8, configured to be capable of performing recording of audio data as the record data and reproduction of voice or sound based on the audio data, and wherein when the recording control section determines by audio analysis of the audio data to be recorded on the recording medium that the audio data to be recorded corresponds to a predetermined word or a predetermined sound component, the recording control section records the index data for detecting the cue position corresponding to the audio data to be recorded.

11. A digital recording/reproducing apparatus according to any one of claims 9, configured to be capable of performing recording of audio data as the record data and reproduction of voice or sound based on the audio data, and wherein when the recording control section determines by audio analysis of the audio data to be recorded on the recording medium that the audio data to be recorded corresponds to a predetermined word or a predetermined sound component, the recording control section records the index data for detecting the cue position corresponding to the audio data to be recorded.
